(19) United States
(12) Patent Application Publication
(10) Pub. No.: US 2013/0124337 A1
(43) Pub. Date: May 16, 2013

(54) METHOD FOR EXTRACTING METADATA FOR E-COMMERCE OFFERINGS FROM VARIABLE DATA CAMPAIGN CONTENT

(71) Applicants: Dale Ellen Gaucas, Penfield, NY (US); Michael David Shepherd, Ontario, NY (US); Kirk J. Ocke, Ontario, NY (US); Ranen Goren, Closter, NJ (US); Reuven J. Sherwin, Ra'anana (IL)

(72) Inventors: Dale Ellen Gaucas, Penfield, NY (US); Michael David Shepherd, Ontario, NY (US); Kirk J. Ocke, Ontario, NY (US); Ranen Goren, Closter, NJ (US); Reuven J. Sherwin, Ra'anana (IL)

(73) Assignee: XEROX CORPORATION, Norwalk, CT (US)

(21) Appl. No.: 13/293,380

(22) Filed: Nov. 10, 2011

(51) Int. Cl. G06Q 30/02

(52) U.S. Cl. 705/14.67

(57) ABSTRACT

A method and system for making marketing campaigns discoverable to non-recipients via, for example, the Internet. In one example, information from a VDP marketing campaign is used to generate metadata that is embedded in web pages that support the VDP campaign. A non-recipient Internet user may discover the VDP campaign through various paths, such as via search engine results returned to the user during a web search.

### BACKGROUND

Data suggests that somewhere between 30-40% of marketing campaigns are personalized, most of which only vary content based on the recipient's name. First-name and last-name are simple textual data values that can be leveraged in a limited capacity on a personalized document (e.g., embedded in textual message or in an image). As CRM (customer relations management) systems become more sophisticated, much more data becomes available in which campaigns can be personalized for customers or prospects. The data (e.g. first-name, last-name, age, gender) and logic (a.k.a “business rules”—e.g. “if gender is male and age is less than 30, then special offer=iPhone otherwise special offer=Blackberry) aspects of a variable data publishing (VDP) plan creation are difficult and time consuming. Marketing Service Providers (MSPs) invest large amounts of time understanding the desires of the campaign customer, testing the specific campaign requirements, and creating the logic necessary to fulfill the campaign intent.

While the creation of VDP campaigns allows targeted marketing to be delivered to specific individuals, the details of the campaign are not generally discoverable by potential customers outside of the campaign.

### BRIEF DESCRIPTION

The present disclosure sets forth methods and systems for making VDP marketing campaigns discoverable to non-recipients of the VDP marketing campaign via, for example, the Internet. In one example, information from a VDP marketing campaign is used to generate metadata that is embedded in web pages that support the VDP campaign. A non-recipient Internet user may discover the VDP campaign through various paths, such as via search engine results returned to the user during a web search.

In accordance with one aspect, a computer-implemented method for extracting metadata for e-commerce offerings from a variable data publishing (VDP) marketing campaign comprises loading a VDP marketing campaign, identifying semantically represented content objects from the VDP campaign where content objects are placeholders in a campaign document that contain static or variable information, mapping the identified semantically represented content objects to an e-commerce metadata vocabulary, expressing the content of the mapped content objects as e-commerce metadata, and embedding the e-commerce metadata in at least one marketing campaign web page related to the VDP marketing campaign.

In one exemplary embodiment, the method can further comprise, prior to the embedding, converting at least some of the metadata to RDFa snippets. The at least one web page can be published to a web of linked data. The method can further include identifying a content object in the VDP campaign that is not semantically represented and, using a descriptive content object name and lexical techniques such as synsets, mapping the content object to an e-commerce metadata vocabulary and expressing the content of the mapped content object as e-commerce metadata. In addition, the method can also include identifying a tag in the campaign's layout template and, using a descriptive tag name and lexical techniques, mapping the tag to an e-commerce metadata vocabulary and expressing the tagged content as e-commerce metadata.

The method can further include augmenting the metadata with additional metadata derived from data sources used in creating the VDP campaign. The data sources can include at least one of a product information database or a company information database. A user can be presented with a readable version of the retrieved metadata for editing by the user. A processor can be configured to execute computer-executable instructions for performing the method, the instructions being stored on a computer-readable medium. In accordance with another aspect, a system that facilitates extracting metadata for e-commerce offerings from a variable data publishing (VDP) marketing campaign comprises a graphical user interface (GUI) via which a user interacts with a semantically-based campaign creation application that is persistently stored on a computer-readable medium, and a processor that executes the campaign creation application. The processor is configured to, load a VDP marketing campaign, identify semantically represented content objects from the VDP campaign, map the identified semantically represented content objects to an e-commerce metadata vocabulary, express the content of the mapped content objects as e-commerce metadata, and embed the e-commerce metadata in at least one marketing campaign web page related to the VDP marketing campaign.

The processor can be further configured to generate the VDP marketing campaign prior to the loading, wherein the generating includes receiving user input related to an intended campaign purpose from a non-expert user, automatically selecting a VDP pattern from a plurality of a pre-generated VDP patterns as a function of the intended campaign purpose, retrieving product information to be presented on campaign documents for distribution to a plurality of recipients, the product information being retrieved from a product data source provided by the user, receiving recipient information to appear on the campaign documents, the recipient information being provided in a recipient data source provided by the user, prompting the user, as a function of the intended campaign purpose, to specify personalization parameters for personalizing the campaign documents, receiving user-specified personalization parameter information, and outputting a VDP campaign.

The processor can also be configured to do any one or more of the following: i) convert at least some of the metadata to RDFa snippets prior to embedding in at least one page; ii) publish the at least one web page to a web of linked data; iii) present a user readable version of the metadata for editing by a user via the GUI; iv) identify any content objects in the VDP campaign that are not semantically represented, and, using a descriptive content object name and lexical techniques (such as a Thesaurus), map the content objects to an e-commerce metadata vocabulary; v) express the content of the mapped content object as e-commerce metadata; and/or vi) augment the metadata with additional metadata derived from data sources used in creating the VDP campaign.

In accordance with another aspect, a computer-readable medium having persistently stored thereon computer-executable instructions for extracting metadata for e-commerce offerings from a variable data publishing (VDP) marketing campaign pattern, comprises instructions for loading a VDP marketing campaign, identifying semantically represented content objects from the VDP campaign, mapping the identified semantically represented content objects to an e-commerce metadata vocabulary, expressing the content of the mapped content objects as e-commerce metadata, and embedding the retrieved metadata in at least one marketing campaign web page related to the VDP marketing campaign.

### BRIEF DESCRIPTION OF THE DRAWINGS

FIG. 1 illustrates a method for identifying campaign designer intent in which a VDP non-expert user can express the desired VDP logic for a personalized marketing campaign.

FIG. 2 shows an example VDP Pattern called “Product Offer.”

FIG. 3 illustrates a plurality of examples of VDP patterns, such as may be employed in conjunction with various aspects described herein.

FIG. 4 illustrates a system that facilitates identifying user intent when generating a marketing campaign in order to infer an appropriate VDP pattern and populate the pattern with personalized information, in accordance with one or more aspects described herein.

FIG. 5 is a screenshot of an exemplary campaign document.

FIG. 6 shows a screenshot of exemplary search engine results including Good Relations e-commerce metadata.

FIG. 7 is a flowchart of an exemplary method in accordance with the disclosure.

### DETAILED DESCRIPTION

The above-described problem is solved by providing a knowledge-assisted method in which a VDP (variable data printing/publishing) non-expert can express his or her desired VDP logic for a VDP campaign. The technique is supported by a knowledge-base (e.g., a database+entity logic) of common types of VDP campaigns. Through the semantic expression of VDP elements and logic, the MSP can more easily and accurately convey the desired campaign intent to the team members collaborating on the campaign. Additionally, the MSP can more accurately align the execution of the campaign as expected by the client, as the patterns provide a more natural nomenclature for expressing campaign intent. Expression of campaign intent can automatically be reified into an executable campaign plan and corresponding data schema.

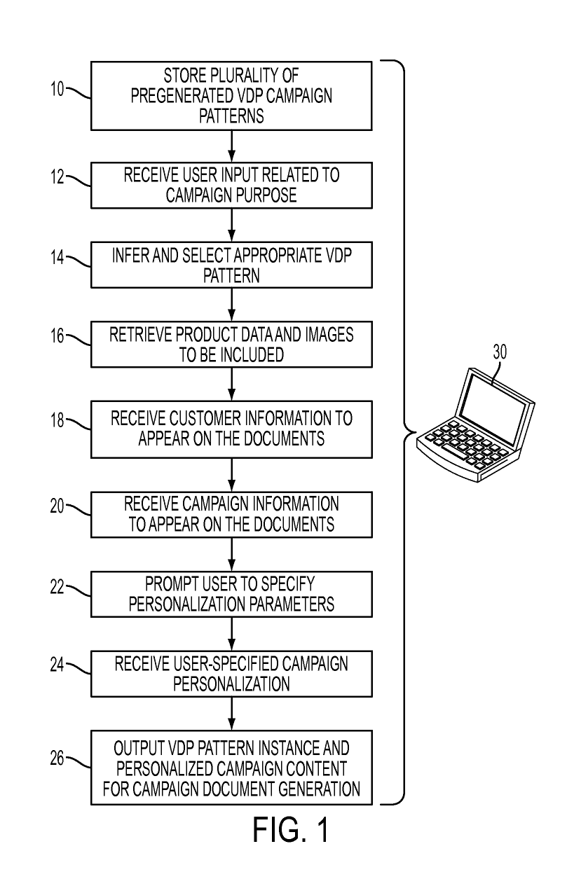

FIG. 1 illustrates a method for identifying campaign designer intent in which a VDP non-expert user, also referred to herein as a “campaign designer,” can express the desired VDP logic for a personalized marketing campaign. Accordingly, at 10, a plurality of pre-generated campaign patterns are stored (e.g., in a memory, computer-readable medium, etc.). These campaign patterns are hereafter referred to as “VDP Patterns.” Types of VDP Patterns include, without being limited to, Product Offer, Advertisement, Solicitation, Invitation, Announcement, Recall, Reminder, Survey, Greeting Card, Itinerary, etc. Additionally, each VDP Pattern is semantically defined and represented to contain VDP elements specific to that VDP Pattern. “VDP elements” denote high-level concepts that are typically populated by variable content. At 12, user input is received, which describes a campaign purpose (e.g., a sale, incentive, service, etc.). At 14, an appropriate VDP pattern is inferred based on the user's indicated campaign purpose and selected for populating with user-provided recipient-specific information. At 16, existing data and images to be used in the VDP pattern are received. The existing data and images can be entered (e.g., downloaded) by the campaign designer and/or can be selected from a database of stored images and/or data.

At 18, customer information to appear on the campaign documents is received. For instance, the designer can download or import customer data from a source, such as a spreadsheet or the like. At 20, campaign information to appear in the document(s) is received. Campaign information may include, for instance, a coupon or reward, a sale data and location, or any other information the designer wishes to disseminate to one or more customers. At 22, the user is prompted to specify personalization parameters for the campaign. User prompts are a function of the selected VDP pattern, which in turn has been selected as a function of the user's specified campaign intent. At 24, user-specified campaign personalization is performed. For instance, a user may wish to personalize the VDP pattern to include variable data such as name, nearest store to the named customer, and coupon size (e.g., which may be a function of an amount the named customer spent at the store in a previous time period or the like). At 26, the personalized VDP pattern and campaign content are output (e.g., on a graphical user interface, via a print-out, via email, or some other suitable means) for review and verification and for generating the campaign documents (e.g., personalized emails, post cards, mailers, web-based advertisements, etc.).

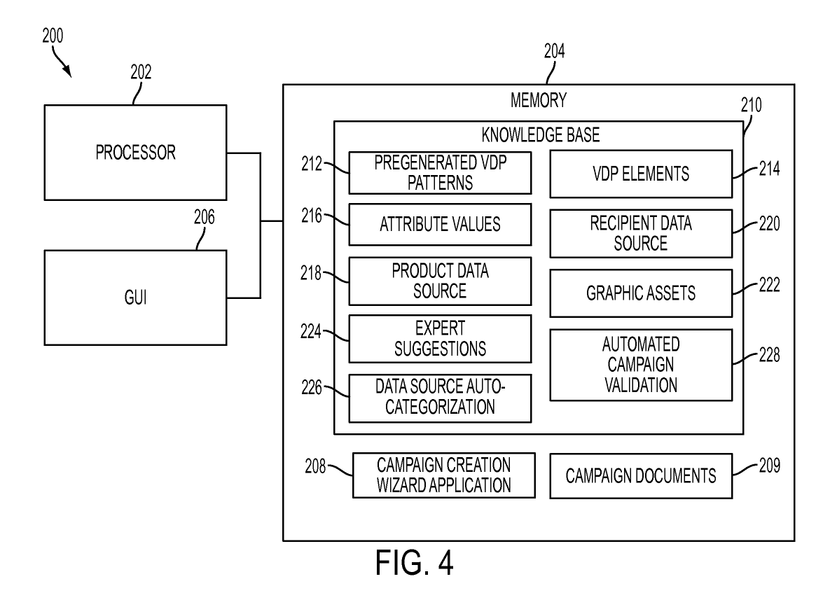

It will be appreciated that the method of FIG. 1 can be implemented by a computer 30, which comprises a processor (such as the processor 202 of FIG. 4) that executes, and a memory (such as the memory 204 of FIG. 4) that stores, computer-executable instructions for providing the various functions, etc., described herein.

The computer 30 can be employed as one possible hardware configuration to support the systems and methods described herein. It is to be appreciated that although a standalone architecture is illustrated, that any suitable computing environment can be employed in accordance with the present embodiments. For example, computing architectures including, but not limited to, stand alone, multiprocessor, distributed, client/server, minicomputer, mainframe, supercomputer, digital and analog can be employed in accordance with the present embodiment.

The computer 30 can include a processing unit (see, e.g., FIG. 4), a system memory (see, e.g., FIG. 4), and a system bus (not shown) that couples various system components including the system memory to the processing unit. The processing unit can be any of various commercially available processors. Dual microprocessors and other multi-processor architectures also can be used as the processing unit.

The computer 30 typically includes at least some form of computer readable media. Computer readable media can be any available media that can be accessed by the computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above can also be included within the scope of computer readable media.

A user may enter commands and information into the computer through an input device (not shown) such as a keyboard, a pointing device, such as a mouse, stylus, voice input, or graphical tablet. The computer 30 can operate in a networked environment using logical and/or physical connections to one or more remote computers, such as a remote computer(s). The logical connections depicted include a local area network (LAN) and a wide area network (WAN). Such networking environments are commonplace in offices, enterprise-wide computer networks, intranets and the Internet.

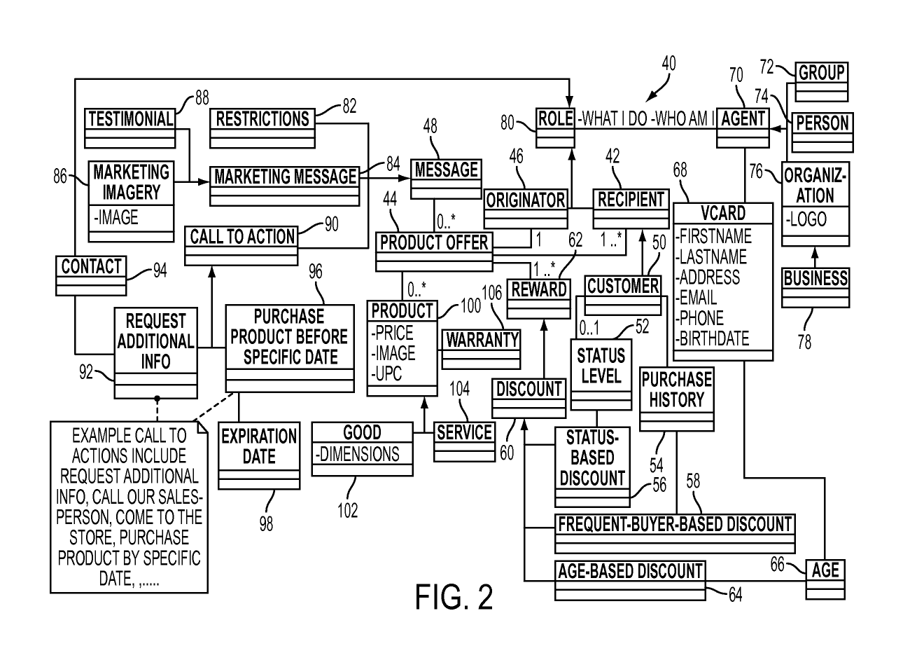

FIG. 2 shows an example VDP Pattern 40 called “Product Offer.” The surrounding boxes are the supporting VDP elements. “Element” as used herein denotes both a computer-readable medium or portion thereof that stores information, as well as a populatable and personalizable field into which the information may be entered by a user. For instance, a user may enter information into a given field presented to the user on a graphical user interface, and/or the information may be downloaded or extracted from an electronic document or source and automatically entered into appropriate fields. Once entered, the information is then stored at a predefined location in a system memory. Although the herein-described knowledge-base has in-depth knowledge of the relationships between elements, the system and method defined herein uses the VDP concepts most directly related to the specific VDP Pattern for illustrative purposes. Some VDP elements are shared across many VDP Patterns. For instance, every VDP Pattern, by the definition of VDP campaign, has a recipient element 42. As another example, Offers, Recalls, and Warranty Extensions typically all share the Product element 44. Different campaigns can use different VDP elements of the VDP Patterns. In one embodiment, some elements may be mandatory while others may be optional.

The VDP pattern 40 also includes an originator element 46 that originates the offer or marketing campaign, as well as a message element 48 that includes a message for the recipient. The recipient may be a customer of the campaign designer (e.g., a merchant), and therefore the pattern 40 includes a customer element 50. Each customer has a status level 52 and a purchase history 54, which can be analyzed to generate a status-based discount 56 and/or a frequent-buy-based discount 58. Information from the status-based discount element 56 and/or the frequent-buyer-based discount element 58 is provided to a discount element 60, which in turn provides information to a reward element 62 that generates a reward for inclusion in the product offer 44. An age-based discount element 64 can provide age-based discount information to the discount element 60. A customer's age 66 is stored or determined by an age element 66, such as by analyzing or storing a vcard 68 or the like.

The VDP pattern 40 also includes elements associated with an agent who is involved in the marketing campaign. For instance, an agent element 70 comprises information regarding the identity of the agent, which may be collected from a group element 72 that identifies multiple agents, from a person element 74 that identifies a single agent, and/or from an organization element 76 that identifies an organization that acts as an agent. A business element 78 includes information related to the business of the organization acting as an agent. The agent element has is populated with a desired level of information describing the identity of the agent, and is associated with a role element 80 that includes information related to one of more functions or services provided by the agent.

The message element 48 can include one or more message types such as one or more restrictions on the product offer, which are stored in a restrictions element 82. The message may also include a marketing message that is stored in a marketing message element 84. The marketing message may include marketing imagery obtained from a marketing imagery element 86 that stores images, as well as testimonial information (i.e., testimonials for satisfied customers or the like) that are stored in a testimonial element 88. Additionally, the message 48 can include one or more calls to action that are stored in a call to action element 90. In one example, the call to action includes a request for additional information 92, in which case a contact element 94 is executed to contact either the recipient of the product offer or an agent (e.g., via the role element 80) who then contacts the recipient. In another example, the call to action includes an offer deadline, e.g., stored in a “purchase product before specific date” element 96. The deadline information for a given product offer is stored in an expiration date element 98.

The product offer 44 may also include product information, which is stored in a product element 100, and which may include, without limitation, one or more of product price, an image of the product, UPC information for the product, etc. A good element 102 includes product information for one or more goods, such as dimension and the like, while a service element 104 includes information related to a service that is to be offered. A warranty element 106 includes information related to product warranty, which can be included in the product offer 44.

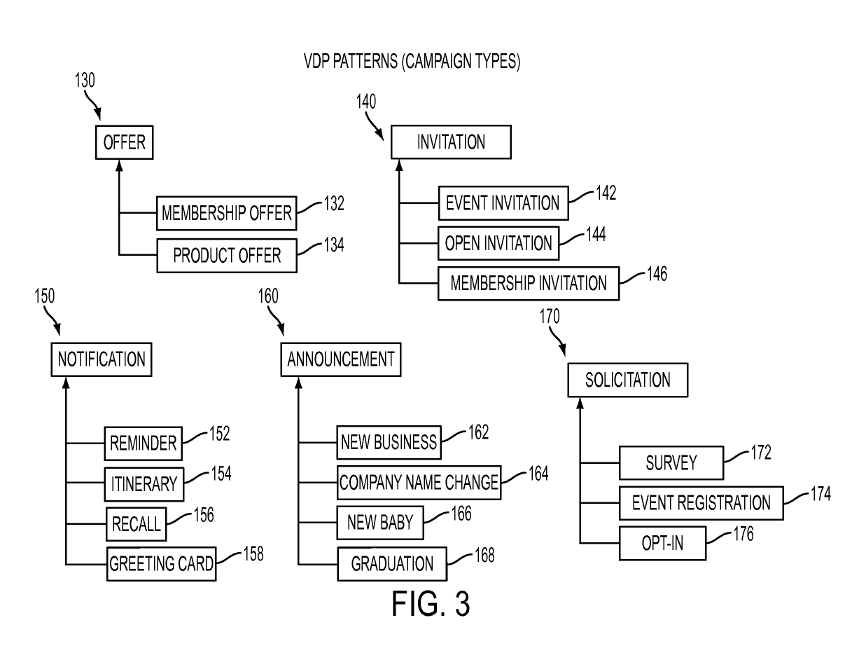

FIG. 3 illustrates a plurality of examples of VDP patterns, such as may be employed in conjunction with various aspects described herein. An offer VDP pattern 130 can include, for example, a membership offer 132 and/or a product offer 134. An invitation VDP pattern 140 can include, for example, an event invitation 142, an open invitation 144, and/or a membership invitation 146. A notification VDP pattern 150 may include, for example, a reminder 152, an itinerary 154, a product recall 156, and/or a greeting card 158. An announcement VDP pattern 160 can include, for example, a new business announcement 162, a company name change announcement 164, a new baby announcement 166, and/or a graduation announcement 168. A solicitation VDP pattern 170 can include, for example, a survey 172, an event registration form 174, and/or an opt-in form 176.

FIG. 4 illustrates a system 200 that facilitates identifying user intent when generating a marketing campaign in order to infer an appropriate VDP pattern and populate the pattern with personalized information, in accordance with one or more aspects described herein. The system comprises a processor 202 that executes, and a memory 204 that stores computer-executable instructions for performing the various functions, methods, techniques, steps, and the like described herein. The processor 202 and memory 204 may be integral to each other or remote but operably coupled to each other. In another embodiment, the processor and memory reside in a computer (e.g., the computer 30 of FIG. 1). The system further comprises a GUI 206 via which information is presented to the non-expert user (i.e., a layman marketing campaign designer, such as a store or small business owner or the like), and via which the user enters information to the system. The GUI 206 may also be integral to the computer 30.

The memory persistently stores data and computer-executable instructions for performing the described functions, methods, techniques, and the like. For instance, the memory 208 stores a campaign creation wizard module that is executed by the processor to receive information from the user, analyze received information, and output the business logic for a marketing campaign for to the user. In this manner, the wizard module 208 walks the non-expert user through the campaign design process in order to generate the business logic for the marketing campaign that targets the user's customers with personalized campaign documents 209 (e.g., post cards, mailers, emails, web-based ads, or any other suitable campaign media.

As stated above, the system 200 comprises the processor 202 that executes, and the memory 204 that stores one or more computer-executable modules (e.g., programs, computer-executable instructions, etc.) for performing the various functions, methods, procedures, etc., described herein. Additionally, “module,” as used herein, denotes a set of computer-executable instructions, software code, program, routine, or other computer-executable means for performing the described function, or the like, as will be understood by those of skill in the art. Additionally, or alternatively, one or more of the functions described with regard to the modules herein may be performed manually.

The memory may be a computer-readable medium on which a control program is stored, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, RAM, ROM, PROM, EPROM, FLASH-EPROM, variants thereof, other memory chip or cartridge, or any other tangible medium from which the processor can read and execute. In this context, the systems described herein may be implemented on or as one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like.

A knowledge-base 210 (i.e., a computer-readable medium) of VDP patterns 212 is pre-constructed, e.g., by a knowledge engineer, and provided to such a system. The VDP patterns are represented using the vocabulary of the non-expert. Additionally, given a starting knowledge-base, the VDP patterns are also amenable to extension by the campaign designer (non-expert), graphic artist, VDP logic developer, or other campaign developer.

The systems and methods described herein are supported by the wizard module 208, which can accept the campaign designer's desired campaign intent and automatically express and store the campaign intent as one or more instances of VDP patterns 212 and VDP elements 214 (see, e.g., FIGS. 2 and 3). The described systems and methods use an underlying infrastructure to transform the provided instances into initial VDP plan logic that can be used by the logic developer to create the final VDP plan logic. The plan logic incorporates the rules, data schema, and content objects exported to the design. This arrangement also provides the logic developer and/or data specialist with a skeleton of the information expected to be available in the data, and as such can “flag” early on data inconsistencies or shortcomings. Sufficiently simple campaign plan logic could be used to compose the campaign documents without need for a logic developer.

The campaign designer first expresses (e.g., via the GUI 206) the type of VDP campaign they would like to create. This can occur in various ways. For instance, one approach is that all VDP patterns 212 stored in the knowledge-base 210 are presented to the campaign designer for them to choose from. To help select and instantiate a VDP pattern, the campaign designer may be presented with one or more examples in the form of a natural language (NL) sentence. The scope of the natural language used in this embodiment corresponds to the vocabulary of the VDP patterns, which represents the knowledge of the non-expert. Sentence examples may include, without limitation:
I want to send out a promotion to my new health club service.
I want to send out a recall notice for a specific tire model.
I want to send out notifications that a car warranty is expiring.
I want to send out (event) invitations to my family for a 50th wedding anniversary.
I want to up-sell my top customers by offering a variable discount on a new TV on their birthday.
I want to send out an announcement that my business is moving to a new location.
I want to send an (open) invitation for people to join my stamp collecting club.
I want to send out an advertisement to my customers announcing that we carry new finishing butters.
I want to send out customer satisfaction surveys to recent car repair clients.
I want to send personalized holiday greeting cards to all of my friends.

Each VDP pattern 212 is supported by a natural language description that consists of all high-level VDP elements 214 associated with that VDP pattern. The associated VDP elements are “parameterizable” pieces of the NL description. Some examples include:

Product Offer:
For each recipient, my Product Offer will promote <Product> by offering <Reward> if the recipient takes <Call To Action>, with possible <Restrictions>.

Announcement:
For each customer, my Announcement will convey new <Information> with the <Benefit> to the customer with a possible <Call To Action>

Event Invitation:
My Event Invitation will invite each invitee to <Event> at designated <Venue> at a particular <Time> with a desired <Call To Action>, with possible <Restrictions>.

Each VDP element parameter (shown above in brackets < >) is provided as a semantic placeholder for the user to define VDP content. The campaign designer selects the VDP element from the sentence and may then enter any number of options to use as VDP content. For example, a pet store campaign designer selects the <Product> concept and inputs to the system the following product descriptions:

Iams Hairball-Control Cat Food

Flexi Retractable Dog Leash

Habitrail Hamster Habitat

BioCube Aquarium

Each product description is automatically created as a product instance in the knowledge-base of VDP patterns. In cases where multiple values are entered, it is inferred that the VDP element “Product” is variable content, and that a rule is desirable to determine which specific product description to use for each recipient. The campaign designer is then requested to enter the semantics of the data source that will determine the variable content of product for a particular recipient. To further the present example, the campaign designer specifies “pet preference” and assigns data values “cat,” “dog,” “hamster,” and “fish,” respectively. The “Product” VDP element in this case is denoted as “variable” in the knowledge base and each instance of the Product is tagged with the data value that is used to select it as variable content.

The data value may be implicit or explicit, and may come from any number of sources. Examples of data value extraction sources include, without limitation: the value may come from a database expert who mines customer purchase history to determine “pet preference’; from a specific pre-existing data field available in a data source; or from automated techniques for determining available data implicit in a given data source.

Continuing the example, the campaign designer selects the <Reward> concept and is offered choices for the type of Reward such as a Frequent-Buyer-Based Discount. The designer may then choose to vary such a discount based on the amount of purchases (e.g., number of purchases, total amount spent on all purchases, etc.) for the past predetermined period (e.g., 12-months). Variable rewards are specified of e.g. “30%”, “20%”, and “10%” and are offered to customers who have specified “spend level” of values e.g. “over $1000”, “between $500 and $1000”, and “less than $500” respectively. The Reward VDP element of Product Offer in the knowledge base is then denoted as “variable” and instantiated with these values, as was done for the Product VDP element above.

In a related example, the campaign designer wants the Call To Action element to be the same for all customers. The designer selects the <Call To Action> concept and enters a single value of “Redeem this offer at our store before June 30^{th}.” The Call To Action VDP element in the knowledge base is set to “static” and instantiated with a single value. It will be appreciated that any VDP Pattern can be extended to include additional Promotional Messages, whether they are text or images. One option that the campaign designer may select is to include variable or static Promotional Messages in the VDP document. Continuing with the above pet store example, the campaign designer may provide various sets of graphic assets that they will use to provide an attractive marketing “feel” or aesthetic quality to the campaign document.

In some instances, the designer may desire to reuse the “pet preference” semantic data in which he desires to use imagery from a “cat” graphic asset folder or database when the pet preference is “cat”, a “dog” graphic asset folder when the pet preference is “dog,” etc. The graphic assets can also be pulled from a content management system that is connected to the wizard application. The designer can also specify variable text messages that include testimonials from cat-owners for the “cat” pet preference, testimonials from dog-owners for the “dog” pet preference, etc.

Once the knowledge base is populated with all desired instances that represent the campaign for a particular VDP pattern, the full instantiation of the campaign is then transformed into a partially-populated or, in some cases, a fully-executable, VDP plan. The transformation automatically creates all the content objects, the logic for determining the variable content, and the data schema needed to support the campaign plan, as well as stores the graphic asset files so they are accessible by the VDP environment. In a specific example in which Xerox's XMPie™ suite is employed, this feature creates an XMPie plan file for the uPlan™ logic definition application.

The VDP elements in the knowledge base may also contain various attributes 216 specific to a given element. For instance, a Product element may have single- and multi-valued attributes such as “price,” “image,” universal product code or “UPC,” etc. In one embodiment, a means for the campaign designer to specify values for the attributes of a VDP element is provided. The attribute values for the element are then made available as content when the corresponding VDP element is selected for a particular dynamic document. In one embodiment, the campaign designer downloads or otherwise generates a product data source 218 (e.g., a list, spreadsheet, or other data source comprising information relating to the products to be included on the campaign documents).

For instance, as the campaign designer is inputting the <Products> for the pet store campaign, he can specify a price and an image of each Product that is to appear on the marketing documents. In one example, upon entering the Product description, the campaign designer indicates a price and image that the product (e.g., a hamster habitat) will have, as associated attribute values. When providing associated values, known values are encoded directly into the knowledge base associated with the <Product> instance. Additionally or alternatively, an attribute value lookup is performed to identify the associated attribute value(s). In another embodiment, the associated value is initially left blank for later value assignment. A VDP element's attributes list may be obtained through various means with the GUI. Entries are made in the knowledge base that capture the campaign intent that the selected attributes represent variable content, as well as whether the selected attributes are graphics or text.

Continuing with the example, the campaign designer specifies known <Product> attribute values using the methods described herein. Table 1 shows examples of product attribute values 216, such as can be extracted from the product data source 218 by the processor 202 when executing the wizard 208, and/or entered directly by the campaign designer.

TABLE 1

| Product | Price | Image | UPC |
|---|---|---|---|
| Hairball Control | $30 | Image1.jpeg | 019014230079 |
| Food | | | |
| Retractable Dog | $20 | Image2.TIFF | 047181025019 |
| Leash | | | |
| Hamster Habitat | $25 | Image3.GIF | 080605626003 |
| Aquarium | $80 | Image4.PNG | 797926820514 |

The wizard 208 employs campaign intent that may include references to images. It will be appreciated by those of skill that any suitable image type or format may be employed by the subject systems and methods. While Table 1 illustrates four image file formats (jpeg, TIFF, GIF, and PNG), it will be understood that the herein-described systems are not limited thereto.

If the campaign designer desires the recipient's first name to appear on the dynamic document, then the designer indicates that they want the ‘firstName’ of the recipient to be variable and designate the assignment be to set up by a data specialist. The data specialist and/or logic developer then use this designer-specified campaign intent knowledge to modify the automatically created plan file to extract the appropriate value for the recipient's first name out of a recipient data source 220, which may be provided by the designer (e.g., a spreadsheet comprising a list of the designer's customers or a subset thereof, a database, a comma-delimited list of customers, etc.).

The knowledge base 210 also includes graphic assets 222 (e.g., images, icons, logos, etc.), that the user can select to personalize the campaign documents. Additionally, the expert suggestions are stored in the knowledge base and can be retrieved and presented to the user when the wizard determines that the user's VDP pattern can benefit from automatic suggestions of meaningful actions for the user to take. Additionally, the knowledge base 210 includes a data source auto-categorization module 226 that automatically determines the semantic categories of the data values (e.g., first name, last name, zip code, spend level, pet type, etc.) in each column or row of a downloaded data source. An example of a data source auto-categorization technique that may be employed in conjunction with various aspects described herein is found in U.S. patent application Ser. No. 12/857,997, filed on Aug. 17, 2010 and entitled “Semantic Classification of Variable Data Campaign Information,” which is hereby incorporated by reference herein in its entirety. An automated campaign validation module 228 continuously or periodically checks the campaign pattern during the design states for errors. If an error is detected, the wizard application prompts the user to correct the errors and walk the user through the corrective actions.

As will be appreciated, personalized campaigns are accomplished through the use of dynamic documents, each of which contains content that is specific and relevant to a particular recipient. The data that drives the dynamic content not only can originate from a recipient data source which contains information about all potential recipients of the campaign, but also from auxiliary non-recipient data sources that contain information not specific to the individual recipients. Examples of non-recipient data sources include data sources describing products, cities, countries, organizations, venues, events, vehicles, etc.

Campaign designers will formulate requirements for variable-data marketing campaigns that include the particular categories of data which they desire to use as the dynamic content in the VDP campaign. These categories of data can include both recipient data and, as noted, non-recipient data. Often times the campaign designer will desire to render information on the dynamic document that is not readily accessible via a data source they have on hand, or their data source may be missing the desired information. In such cases, the system 200 and/or wizard 208 can be configured to access information from other sources to facilitate the creation of a desired data source for a VDP campaign.

One potential source of information are Encyclopedic Knowledge-Bases (EKB). EKBs semantically capture a wide expanse of knowledge through the use of Linked Data and ontological representations. Semantic mark-up of sites such as Wikipedia provide specific references to content which can be linked together into a Resource Description Framework (RDF) Data Model to provide a web of Linked Data. Additionally, ontologies provide a structured knowledge framework to semantically convey certain meanings on the relationships in the Linked Data. These ontologies include DBpedia (RDF of Wikipedia), GoodRelations (RDF of commercial details of Business Offering), eClassOWL (RDF of type and features of products or services), Consumer Electronics Ontology, FOAF (RDF of social networks), etc.

Queries about particular entities can be posed to EKBs which return a vast set of information about the entity's types, properties, and relationships with other entities. This can be accomplished through the use of an RDF query language called SPARQL, for example.

As described above, the campaign designer may desire to render non-recipient data on the VDP campaign's dynamic documents. The campaign designer expresses a requirement (or campaign intent) to select data about a particular entity. This can be done in the context of a campaign brief, via a new VDP Pattern Element as described in commonly assigned U.S. patent application Ser. No. 13/211,437 filed on Aug. 17, 2011, (Atty Docket No. 20100239-US-NP/XER202535US01), which is hereby incorporated by reference in its entirety, or through discussion with a VDP data expert.

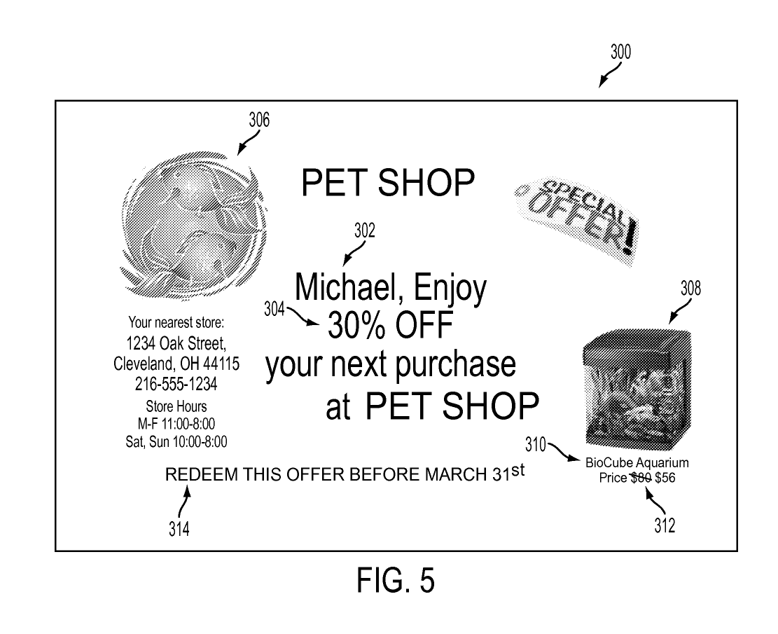

With continued reference to the preceding FIGURES, FIG. 5 shows a screenshot of an example advertisement 300 or offer that is presented to a recipient by a pet store merchant or proprietor. Variable data (e.g., recipient names, spend levels, pet preference, pet names, etc.), is extracted from a recipient data source such as a spread sheet or the like maintained by the merchant or proprietor offering the product. An example of a recipient data source, such as the recipient data source 220 of FIG. 4, is shown in Table 2.

TABLE 2

| | | | Customer | Customer | Customer | |
|---|---|---|---|---|---|---|
| | First | Last | Spend | Pet | Pet | Zip |
| ID | Name | Name | Level | Preference | Name | Code |
| 1 | Michael | Shepherd | 720 | fish | | 10005 |
| 2 | Kirk | Ocke | 260 | dog | | 90212 |
| 3 | Dale | Gaucas | 405 | cat | | 60622 |
| 4 | Lee | Moore | 210 | hamster | Cotton | 60625 |
| 5 | Barry | Gombert | 450 | bird | | 10011 |
| 6 | Karen | Braun | 660 | dog | Fido | 91230 |
| 7 | Al | Coté | 850 | fish | | 60623 |
| 8 | Mike | Kehoe | 65 | bird | | 90210 |
| 9 | Mohit | Seth | 155 | hamster | | 10018 |

The ad 300 includes several variable data fields that have been populated using the described wizard application. For instance, a recipient's name 302 is personalized, and a personalized discount 304 is also presented in the advertisement. In the illustrated example, the first recipient has a first name of “Michael,” has a pet fish, and has a high spend level relative to other recipients in the data source. Since it is known from data provided by the marketing campaign designer (i.e., the merchant or proprietor of the store, or the like) that the particular recipient keeps pet fish, a pet image 306 of goldfish is included in the personalized advertisement. Additionally, since the recipient is known to have a pet fish, an aquarium is selected as a potential product for sale, and an image 308 of the product is presented on the ad 300. The product name 310 is also presented, along with the product price 312 (the discounted price and the original price, which is also variable as a function of the given recipient's spend level, customer status level, etc.)

In one example, the product data source includes information related to product identity and price, as shown in Table 3.

TABLE 3

| Product | | | |
|---|---|---|---|
| Name | Product Price | Product Quantity | Customer Rating |
| Iams Cat | $26 | 45 | 4.8 stars |
| Food | | | |
| Flexi Dog | $15 | 63 | 4.5 stars |
| Leash | | | |
| Habitrail | $50 | 12 | 4.3 stars |
| Habitat | | | |
| BioCube | $80 | 8 | 4.5 stars |
| Aquarium | | | |
| Nutriphase | $19 | 22 | 4.1 stars |
| Bird Food | | | |

The system thus applies the discount (i.e., 30% in the example of FIG. 5), which is variable as a function of the particular recipient, to the original price (i.e., $80) to calculate the discounted price (i.e., $56 in this example), which is also presented in the advertisement. Additionally, the advertisement includes a call to action 314 in the form of an “purchase-before” date (e.g., an expiration date for the offer).

When a personalized marketing campaign is created using a VDP environment such as that just described above, information is captured and modeled about the offering such as data about products and services, pricing information, hours of operation, and contact details. In the example above, information exists about the various recipients, their preferences, pet type, etc., as well as information regarding the products that are offered to the recipients through the campaign. All of this information is useful for targeting the campaign. Until now, however, the information utilized by the VDP campaign generally has not been accessible to outside parties and, thus, campaign details have not been discoverable by third parties.

In general, the present disclosure recognizes that as the use of GoodRelations and GoodRelations compliant/supporting web page metadata for describing a business offering becomes more pervasive, it would be useful to have a method for mining such metadata from VDP campaign content. The metadata can be then used to generate RDFa (machine readable information) that can be embedded in (non-personalized) web pages that also support the campaign. Such metadata enables aspects of the campaign's offering to be considered and displayed by search engines, and enables consumers to find those that match their requirements thereby enhancing the overall capability of the VDP application and “reachability” of the deployed campaign. For example, the campaign becomes semantically discoverable in the “web of Data,” and someone who is not an initial recipient of campaign notifications could register to be.

As will be appreciated, GoodRelations is an example of an ontology for annotating offerings and other aspects of e-commerce on the web. The GoodRelations ontology is a standardized vocabulary for creating a description of offers for products and services that can be embedded into web pages and linked open commerce spaces and processed by other systems such as search engines and recommender systems. GoodRelations provides a standard vocabulary for expressing information such as:
that a particular web site describes an offer o sell televisions of a certain make and model at a certain price
that an auto service company offers maintenance and repairs for Italian automobiles
that a truck rental company leases trucks of a certain make and model from a particular set of offices across the country.
   The GoodRelations ontology is a vocabulary for expressing product and service offerings. An example from such a vocabulary would be the ‘gr:legalName’ which corresponds to the concept which is the name of the company that is offering a product or service. A concept such as the name of a company could be included in a campaign knowledge model, for example the model used to generate the campaign described previously. In addition, GoodRelations facilitates expression of most, if not all, commercial and functional details of e-commerce including eligible locations, countries, payment and delivery options, quantity discounts, opening hours, etc. Whereas this patent application uses the GoodRelations ontology, developed by Martin Hepp, (see http://purl.org/goodrelations/) for its example embodiments, the claims herein may be applied in the context of other E-Commerce vocabularies, and is not limited to the use of the GoodRelations ontology.

Using GoodRelations enables an offering's features to be considered and displayed by search engines, and enables consumers to find those that match their requirements. The embedded metadata uses RDFa syntax and the GoodRelations vocabulary to express information about products and services, pricing data, hours of operation, and contact details.

GoodRelations is used in this discussion as the metadata language for offerings because it is currently the most prevalent one, but the method proposed herein can apply to any Business and Product ontological representation. GoodRelations metadata uses the GoodRelations ontology (i.e. vocabulary) to express specific information about a product or service offering instance. An example of such metadata would be gr:legalName=“Petland”. In this case “Petland” is considered to be content which is expressed as GoodRelations metadata in the form of, for example, gr:legalName=“Petland”.

It should be appreciated that GoodRelations and GoodRelations extensions leverage other related vocabularies such as the products and services ontology eClassOWL and the address standard vCard. That is, the GoodRelations ontology does not provide their respective attributes, but is compatible with their use. Specifically, and by way of example, eClassOWL specifies classes, attributes, and values for describing what a product or service is, and vCard captures name, location, and other contact-related information. The GoodRelations vocabulary specifies the details of the actual offer in terms of the relationship between a business entity and a product or service.

In the following discussion, the terms GoodRelations, GoodRelations extensions metadata, and supporting/compliant metadata all refer to or include GoodRelations metadata. Similarly, the term GoodRelations vocabulary/ontology refers to or includes extension and supporting vocabularies/ontologies.

The exemplary method proposed for mining GoodRelations metadata from VDP campaign contents includes a combination of approaches that leverage capabilities of existing VDP environments such as XMPie and knowledge-supported VDP environments such as the one described in U.S. application Ser. No. 13/211,437, filed on Aug. 17, 2011 (Atty Docket No. ID/20100239/XERZ 202535US01) and summarized above. Such environments have various elements from which GoodRelations metadata can be extracted, including:
imported product data sources—the semantics of data columns representing product features can be mined using techniques such as those described in U.S. application Ser. No. 12/857,997, filed on Aug. 17, 2010 and then mapped to the GoodRelations vocabulary
descriptive static and dynamic text objects representing offering and contact information—the semantics of these element names may be derivable from a lexical knowledge-base such as WordNet or an encyclopedic knowledge-base such as DBpedia; such semantics may also come directly from VDP environments that use an underlying knowledge model; the mined semantics can then be mapped to the GoodRelations ontology
campaign logic variation rules—targeted products and product features being promoted by the variable-data campaign may be extracted from the campaign logic code and directly encoded as instances in the GoodRelations ontology
campaign layout templates—graphic design tools such as InDesign support layout tags exportable to XML which can mined for semantics that can then be mapped to the GoodRelations ontology

For example, content objects in a VDP design document (which may have underlying semantic concepts) can be mapped to the GoodRelations ontology/vocabulary. The actual content associated with or stored in the content objects can be expressed/represented as GoodRelations metadata.

The mined GoodRelations metadata can then be converted to the RDFa format required by web pages by using existing methods. Before such a conversion, a readable presentation of the extracted GoodRelations metadata can be presented to the user for modifications and corrections.

GoodRelations metadata in RDFa form can be generated using tools such as the GoodRelations Annotator or GoodRelations Rich Snippet Generator which requires manual entry of the GoodRelations information. The disclosure set forth herein automates part of that information acquisition by leveraging the knowledge that can be gleaned from VDP campaign structures.

The type of information that is modeled by GoodRelations and its supporting/compatible standards includes items, for example, such as the following:
business functions, such as buy, sell, lease, dispose, repair, etc.
product instances, product models, etc.
prices for different types of customers or quantities
product bundles in combination with any kinds of units of measurements
price specifications both as single values or price ranges
intervals and units of measurements for product features
delivery and shipping methods
accepted payment methods, such as Cash, Check, Paypal, COD, debit, bank transfer, MC, Visa, AMEX
offerings constrained to certain eligible business entities
warranty promises such as duration and scope
charges for certain payment or delivery options, such as DHL, UPS, USPS, FedEx, Pick up
company description, such as URI of the main web page, legal name of business, street address, post code, city, country, phone number, sales e-mail, technical contact e-mail
shop or point of sale description, such as name branch or office, location and contact information similar to previous fields, opening hours

The following examples demonstrate the kinds of exemplary metadata that could be extracted from a VDP campaign structure.

### EXAMPLES

Merchant information such as store name, street, city, zip code, phone number, URL for a logo, and hours of operation could be extracted from content objects with descriptive labels within a VDP environment. For example, an XMPie plan file may have an ADOR (Automatic Dynamic Object Replacement) labeled “shop name”. The use of lexicon tools such as a Thesaurus would be required to determine if this label falls into a synset (a group of data elements that are considered semantically equivalent for the purposes of information retrieval) for a GoodRelations entity corresponding to the concept of “name of store.”

Vocabularies for ADORs are more constrained when using knowledge-based VDP environments such as the set forth above. Such environments could support direct mapping of content fields to GoodRelations concepts. For example, a Product Offer pattern may consist of an Originator element with a Phone attribute and a Product with a Price attribute, which in turn can be mapped directly to GoodRelations data.

Product information such as product name, product description, product codes such as UPC and ISBN, product currency and price could also be extracted from descriptive content objects as described above.

Alternatively, a product data source that is imported to VDP environment while creating a Product Offer may have descriptive column headers, or column headers that are inferred by using classification methods, which may be mapped to generic content objects in a VDP campaign. For example, a product data source may have a column with a header “product summary” that is mapped to a content object without underlying semantics. Using lexical techniques, the content object then could be inferred to correspond to the GoodRelations attribute “product description.”

Actual values of product attributes may be derivable from VDP variations rules. For example, if the following rule is defined for a VDP content object that is mapped to the GoodRelations concept of a “ProductOrServiceModel description”, then the two product models being promoted in the campaign can be extracted from this rule about cameras:

if (@{Income} <= 40,000)

“ Canon XS ”

else “ Canon T2 ”

Merchant and Product information could also be mined from descriptive tags in a campaign layout template created by tools such as InDesign (which supports the XMPie uDirect plug-in). For example, InDesign supports the use of a Tags Panel for tagging content that is then exportable to XML. Electronic publishing (ePub) and cross-media publishing make extensive use of the tags in layout templates.

### Examples of GoodRelations Metadata

The following two snippets are examples of GoodRelations metadata in RDFa:

Company information:
<divxmlns:rdf=“http://www.w3.org/1999/02/22-rdf-syntax-ns#”
xmlns:rdfs=“http://www.w3.org/2000/01/rdf-schema#”
xmlns=“http://www.w3.org/1999/xhtml”
xmlns:foaf=“http://xmlns.com/foaf/0.1/”
xmlns:gr=“http://purl.org/goodrelations/v1#”
xmlns:vcard=“http://www.w3.org/2006/vcard/ns#”
xmlns:xsd=“http://www.w3.org/2001/XMLSchema#”>

```
  <div about=“#company” typeof=“gr:BusinessEntity”>
  <div property=“gr:legalName” content=“Hepp's Bagel Bakery Ltd.
```

”></div>

<div rel=“vcard:adr”>
<div typeof=“vcard:Address”>

<div property=“vcard:country-name”
content=“Germany”></div>
<div property=“vcard:locality” content=“Munich”></div>
<div property=“vcard:postal-code” content=“85577”></div>
<div property=“vcard:street-address” content=“1234 Main

```
    Street”></div>
    </div>
</div>
<div property=“vcard:tel” content=“+1 408 970-6104”></div>
<div rel=“foaf:depiction” resource=“http://www.hepps-
bagels.com/image_or_logo.png”></div>
<div rel=“foaf:page” resource=“”></div>
</div>
</div>
```

### Product Information:

<div xmlns:rdf=“http://www.w3.org/1999/02/22-rdf-syntax-ns#”
xmlns:rdfs=“http://www.w3.org/2000/01/rdf-schema#”
xmlns=“http://www.w3.org/1999/xhtml”
xmlns:foaf=“http://xmlns.com/foaf/0.1/”
xmlns:gr=“http://purl.org/goodrelations/v1#”
xmlns:xsd=“http://www.w3.org/2001/XMLSchema#”>

<div about=“#offering” typeof=“gr:Offering”>
<div property=“rdfs:label” content=“Canon Rebel T2i (EOS 550D)
$899”

xml:lang=“en”></div>

<div property=“rdfs:comment” content=“The Rebel T2i EOS 550D is

Cannon's top-of-the-line consumer digital SLR camera. It can shoot up to
18 meagapixel resolution photos and features an ISO range of 100-6400.
Now just $ 899 $” xml:lang=“en”></div>

<div rel=“foaf:depiction” resource=“http://a.img-

dpreview.com/previews/CanonEOS550D/images/intro.jpg”></div>

<div rel=“gr:hasBusinessFunction”

resource=“http://purl.org/goodrelations/v1#Sell”></div>

<div property=“gr:hasEAN_UCC-13” content=“013803123784”

datatype=“xsd:string”></div>

<div rel=“gr:hasPriceSpecification”>

<div typeof=“gr:UnitPriceSpecification”>

<div property=“gr:hasCurrency” content=“USD”

datatype=“xsd:string”></div>

<div property=“gr:hasCurrencyValue” content=“899”

datatype=“xsd:float”></div>

</div>

</div>
<div rel=“gr:acceptedPaymentMethods”
resource=“http://purl.org/goodrelations/v1#PayPal”></div>
<div rel=“gr:acceptedPaymentMethods”
resource=“http://purl.org/goodrelations/v1#MasterCard”></div>
<div rel=“foaf:page”
resource=“http://myshop.com/canon-rebel-t2i/”></div>
</div>
</div>

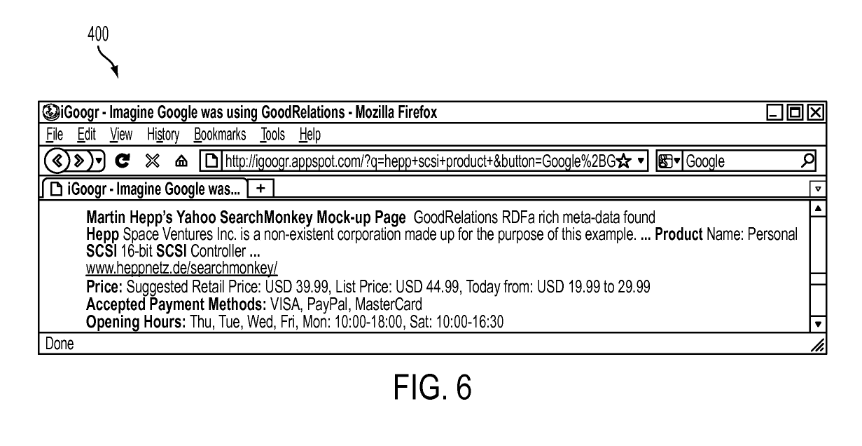

With reference to FIG. 6, a screenshot 400 illustrates an example of how a search engine can use GoodRelations metadata in the display of its search results. These results may be returned to an Internet user in response to a search query relating to SCSI Controllers. As will be appreciated, the special pricing listed in the price category may correspond to a current promotion being advertised via a VDP marketing campaign.

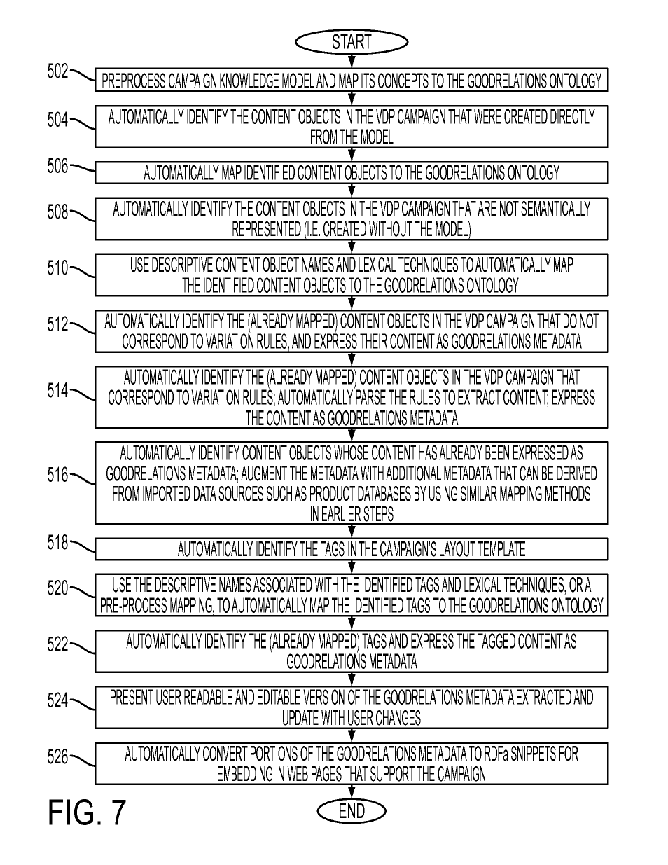

In FIG. 7, an exemplary method 500 in accordance with the disclosure illustrates the above-described techniques for generating metadata from a campaign. The method 500 includes a plurality of steps that can be carried out in a number of different sequences. Thus, it should be understood that the order of the steps as shown and described in connection with FIG. 7 is merely exemplary. Moreover, some of the steps can be omitted and/or repeated as desired for a given application. Some of the steps include multiple substeps and it will be understood that such substeps, in some cases, can be omitted or performed in varying sequences from the sequences illustrated.

Beginning with process step 502, the campaign knowledge model is preprocessed and its concepts are mapped to the GoodRelations ontology. For example, if the campaign knowledge model has an element attribute called ‘business name’, it can be mapped to gr:legalName in the GoodRelations ontology.

In process step 504, content objects in the VDP campaign that were created directly from the model are identified, for example, a content object that was created from the element attribute called ‘business name’. These identified objects are then mapped to the GoodRelations ontology in process step 506.

In process step 508, content objects in the VDP campaign that are not semantically represented in the campaign knowledge model are identified. Such content objects may include those that are inserted as generic placeholders but are given descriptive names such as ‘store hours’. Once identified in process step 508, the content objects that are not semantically represented are mapped to the GoodRelations ontology using descriptive content names and lexical techniques in process step 510.

The method continues to process step 512 where the already mapped content objects in the VDP campaign that do not correspond to variation rules are identified and their contents expressed as GoodRelations metadata. In process step 514, content objects that do correspond to variation rules are identified and parsed to extract content that is expressed as GoodRelations metadata. An example of such parsing is set forth above.

In process step 516, for content objects whose content has already been expressed as GoodRelations metadata, the metadata is augmented with additional metadata that can be derived from imported data sources such as product databases by using similar mapping methods set forth in preceding steps.

Process step 518 continues with identifying the tags in the campaigns layout template. For example, an InDesign layout area could have a tag name such as ‘store address’. These tags are then mapped to the GoodRelations ontology using the descriptive tag name and lexical techniques in process step 520. The mapped tags are then identified and the tagged content expressed as GoodRelations metadata in process step 522.

The user, in process step 524 can then be presented with a readable and editable version of the GoodRelations metadata extracted in the preceding process steps. This allows the user the opportunity to update and edit the metadata as desired. The process concludes in process step 526 wherein at least some portions of the GoodRelations metadata is converted to RDFa for embedding in web pages supporting the VDP campaign.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer-implemented method for extracting metadata for e-commerce offerings from a variable data publishing (VDP) marketing campaign pattern, comprising:
loading a VDP marketing campaign;
identifying semantically represented content objects from the VDP campaign;
mapping the identified semantically represented content objects to an e-commerce metadata vocabulary;
expressing the content of the mapped content objects as e-commerce metadata; and
embedding the e-commerce metadata in at least one marketing campaign web page related to the VDP marketing campaign.

2. A computer-implemented method as set forth in claim 1, further comprising, prior to the embedding, converting at least some of the metadata to RDFa snippets.

3. A computer-implemented method as set forth in claim 1, further comprising publishing the at least one web pages to a web of linked data.

4. A computer-implemented method as set forth in claim 1, further comprising identifying any content objects in the VDP campaign that are not semantically represented, and using a descriptive content object name and lexical techniques to map the content object to an e-commerce metadata vocabulary.

5. A computer-implemented method as set forth in claim 4, further comprising expressing the content of the mapped content object as e-commerce metadata.

6. A computer-implemented method as set forth in claim 5, wherein the lexical techniques include synsets.

7. A computer-implemented method as set forth in claim 1, further comprising identifying a tag in the campaign's layout template and, using a descriptive tag name and lexical techniques, mapping the tag to an e-commerce vocabulary.

8. A computer-implemented method as set forth in claim 1, further comprising augmenting the metadata with additional metadata derived from data sources used in creating the VDP campaign.

9. A computer-implemented method as set forth in claim 8, wherein the data sources include at least one of a product information database or a company information database.

10. A computer-implemented method as set forth in claim 1, wherein the content objects include placeholders in a campaign document that contain at least one of static information and variable information.

11. A computer-implemented method as set forth in claim 1, further comprising presenting a user readable version of the retrieved metadata for editing by a user.

12. A processor configured to execute computer-executable instructions for performing the method of claim 1, the instructions being stored on a computer-readable medium.

13. A system that facilitates extracting metadata for e-commerce offerings from a variable data publishing (VDP) marketing campaign, comprising:
a graphical user interface (GUI) via which a user interacts with a semantically-based campaign creation application that is persistently stored on a computer-readable medium; and
a processor that executes the campaign creation application and is configured to:
load a VDP marketing campaign;
identify semantically represented content objects from the VDP campaign;
map the identified semantically represented content objects to an e-commerce metadata vocabulary;
express the content of the mapped content objects as e-commerce metadata; and
embed the e-commerce metadata in at least one marketing campaign web page related to the VDP marketing campaign.

13. A system as set forth in claim 12, wherein the processor is further configured to generate the VDP marketing campaign prior to the loading, wherein the generating includes:
receiving user input related to an intended campaign purpose from a non-expert user;
automatically selecting a VDP pattern from a plurality of a pre-generated VDP patterns as a function of the intended campaign purpose;
retrieving product information to be presented on campaign documents for distribution to a plurality of recipients, the product information being retrieved from a product data source provided by the user;
receiving recipient information to appear on the campaign documents, the recipient information being provided in a recipient data source provided by the user;
prompting the user, as a function of the intended campaign purpose, to specify personalization parameters for personalizing the campaign documents;
receiving user-specified personalization parameter information;
outputting a VDP campaign.

14. A system as set forth in claim 12, wherein the processor is further configured to convert at least some of the metadata to RDFa snippets prior to embedding in at least one web page.

15. A system as set forth in claim 12, wherein the processor is further configured to publish the at least one web page to a web of linked data.

16. A system as set forth in claim 12, wherein the processor is further configured to present a user readable version of the retrieved metadata for editing by a user via the GUI.

17. A system as set forth in claim 12, wherein the processor is further configured to identify any content objects in the VDP campaign that are not semantically represented, and, using a descriptive content object name and lexical techniques, to map the content objects to an e-commerce metadata vocabulary.

18. A system as set forth in claim 17, wherein the processor is further configured to express the content of the mapped content objects as e-commerce metadata.

19. A system as set forth in claim 12, wherein the processor is further configured to augment the metadata with additional metadata derived from data sources used in creating the VDP campaign.

20. A computer-readable medium having persistently stored thereon computer-executable instructions for extracting metadata for e-commerce offerings from a variable data publishing (VDP) marketing campaign pattern, comprising instructions for:
loading a VDP marketing campaign;
identifying semantically represented content objects from the VDP campaign;
mapping the identified semantically represented content objects to an e-commerce metadata vocabulary;
expressing the content of the mapped content objects as e-commerce metadata; and
embedding the e-commerce metadata in at least one marketing campaign web page related to the VDP marketing campaign.
